(19) United States
(12) Patent Application Publication
(10) Pub. No.: US 2016/0157504 A1
(43) Pub. Date: Jun. 9, 2016

(54) Spreadable High Protein Cream Cheese Products and Methods of Making the Same

(71) Applicant: KRAFT FOODS GROUP BRANDS LLC, Northfield, IL (US)

(72) Inventors: Paloma D. Carrington-Bataller, Golf, IL (US); Janet Z. Batz, Palatine, IL (US); Isabelle Marie Francoise Laye, Wheeling, IL (US)

(21) Appl. No.: 14/900,408

(22) PCT Filed: Jun. 20, 2014
(86) PCT No.: PCT/US2014/043399

§ 371 Date: Dec. 21, 2015

Related U.S. Application Data
(60) Provisional application No. 61/837,990, filed on Jun. 21, 2013.

(51) Int. Cl. A23C 19/076; A23C 19/09

(52) U.S. Cl. CPC A23C 19/076; A23C 19/0917

(57) ABSTRACT

A high protein cream cheese composition having organoleptic characteristics of cream cheese with lower amounts of protein is described. The cream cheese composition may generally include about 8 to about 20 percent total protein provided from a cheese curd, a cultured dairy liquid, and one or more high protein powders. Methods of making the high protein cream cheese composition are also described.

### CROSS REFERENCE TO RELATED APPLICATION

This application claims the benefit under 35 U.S.C. §119(e) of U.S. Provisional Application Ser. No. 61/837,990, filed on Jun. 21, 2013, which is incorporated herein by reference in its entirety.

### FIELD

The field generally relates to cream cheese and cream cheese related products, and more specifically, spreadable cream cheese compositions having high protein contents, and methods of making the same.

### BACKGROUND

Cream cheese is typically a soft, mild acid-coagulated uncured cheese made from a mixture of cream and milk. When making cream cheese, sweet whole milk and/or skim milk and sweet cream are mixed to form a cream cheese mix having a certain fat content. The cream cheese mix may have fat content from about 10% to about 16%. The cream cheese mix is generally pasteurized, homogenized, and cooled, in most instances, to a temperature from about 62° F. to about 92° F. Next, the cream cheese mix is fermented with lactic acid bacteria. Rennet may be used to aid in the coagulation of the cream cheese mix. During coagulation, the curd may be separated from the whey by centrifugation or other techniques. Optional ingredients, such as, for example, salt, stabilizers, and flavoring agents, may be added to the separated curd fraction. Finally, the cream cheese product may be packaged and chilled. The finished cream cheese product may comprise at least 33 weight percent milk fat, a moisture content of up to 55 weight percent, and a pH range of about 4.4 to about 4.9. Many variations to this process have been introduced through the years (see, e.g., U.S. Pat. No. 5,656,320; U.S. Pat. No. 5,079,024; U.S. Pat. No. 5,180,604; U.S. Pat. No. 6,419,975; U.S. Pat. No. 6,406,736; U.S. Pat. No. 6,558,761; U.S. Pat. No. 6,416,797; and U.S. Pat. No. 4,597,971).

Cream cheese and other dairy products are generally good sources of protein as well as other nutrients. The present Recommended Dietary Allowance (“RDA”) for protein, as promulgated by the Food and Nutrition board of the United States National Academy of Science, is 0.8 g protein/kg body weight/day for adults, regardless of age. For example, the RDA for an average adult female is 46 g/day and an average adult male is 56 g/day. Conventional cream cheese may include about 2 grams of protein per 28 gram serving, which typically is about 4 to about 6 percent protein, and about 83-125 mg/100 g of calcium, which is about 2 to 4 percent RDA of calcium.

Attempts to increase the protein level in conventional cream cheese compositions tend to result in processing and/or textural shortcomings such that the cream cheese with higher protein level relative to conventional cream cheeses may compromise undesirable texture, smoothness, and/or other organoleptic properties.

### SUMMARY

A high protein cream cheese composition having organoleptic characteristics of cream cheese with lower amounts of protein is provided herein. The cream cheese composition may generally include about 8 to about 20 percent total protein provided from select combinations of cheese curd, cultured dairy liquid, and one or more high protein powders. The protein powders may have about 70 percent or greater protein relative to the protein powder to aid in providing the high levels of protein herein. The cream cheese composition also include an amount of total fat, but not more than about 14 percent total fat. To aid in obtaining the desired textures, spreadability and organoleptic characteristics of lower protein compositions, the cream cheese compositions herein, in some approaches, also may include a powder-to-moisture ratio from about 0.08 to about 0.25 and a protein-to-fat ratio from about 0.7 to about 3.5 so that the high protein cream cheese composition exhibits the spreadability of cream cheese with lower amounts of protein.

A method of making a high protein cream cheese composition having organoleptic characteristics of cream cheese with lower amounts of protein is also described. The method may include providing a cheese curd having about 6 to about 10 percent protein, about 20 to about 25 percent fat, and a pH of about 4.3 to about 4.6 and then adding a cultured dairy liquid having a higher pH to the cheese curd to raise the pH and form a dairy mixture. Next, the method includes blending one or more high protein dairy powders having about 70 percent protein or more, relative to the dairy powder, into the dairy mixture to form a cream cheese mixture. The mixture may be homogenized to form the high protein cream cheese composition having about 8 to about 20 percent total protein and the spreadability of cream cheese with lower amounts of protein. In some approaches, the unique sequential addition of ingredients aids in forming the high protein cream cheese composition with properly hydrated protein and spreadability, textures, and organoleptic characteristics similar to cream cheese with lower amounts of protein.

### BRIEF DESCRIPTION OF THE DRAWINGS

The various non-limiting embodiments described herein may be better understood by considering the following description in conjunction with the accompanying drawing sheets.

FIG. 1 includes a flow diagram for making high protein cream cheese products by adding protein powder to reduced fat curd.

FIG. 2 includes a flow diagram for making cheese curd according to various embodiments.

FIG. 3 includes a flow diagram for making a cultured dairy liquid, such as a cultured skim retentate, according to various embodiments.

FIGS. 4 and 5 include flow diagrams for making high protein cream cheese compositions, including optional steps, according to various embodiments.

The reader will appreciate the foregoing details, as well as others, upon considering the following description of various non-limiting embodiments according to the present disclosure.

### DETAILED DESCRIPTION

The present disclosure generally relates to cream cheese compositions including a higher level of protein and/or calcium relative to conventional cream cheeses while maintaining a desirable texture, smoothness, and organoleptic properties of cream cheese products with lower amount of protein and/or calcium, as well as methods of making the same. In some approaches, the compositions and methods herein provide for a cream cheese composition including at least double the protein found in conventional cream cheese compositions and products. In some approaches, the compositions herein may include at least about 4 to about 5 grams of protein per about 28 gram serving of cream cheese or in other approaches, about 10 to about 20 percent protein, in yet other approaches, about 12 to about 18 percent protein, and in some instances, about 12 to about 15 percent protein. In yet other approaches, the compositions herein may include at least about 4 to about 5 grams of protein per about 31 or about 32 gram serving of cream cheese.

In some approaches, the cream cheese compositions of the present application include calcium contents higher than conventional cream cheese. This is because calcium may be retained in an added dairy liquid (or other added dairy components) used in some approaches discussed below and compensates for the amount of calcium typically lost in the conventional cream cheese curd. In some approaches, the amount of calcium may be about 280 to about 385 mg per about 100 g of composition, or about 280 to about 350 mg of calcium per about 100 g of composition, or about 300 to about 338 mg per about 100 grams of composition, or about 332 to about 338 mg per about 100 grams of composition. In various embodiments, the cream cheese composition may comprise up to 10% of the RDA, such as greater than about 4% to about 10% calcium, or about 6% to about 10% calcium, or about 6% to about 8% calcium. Such compositions may also include at least double the calcium found in conventional cream cheese compositions and products, such as two to five times more calcium. In various embodiments, the composition may achieve higher levels of calcium without being fortified with added calcium powders or salts.

In one aspect, the compositions and methods herein utilize a unique and select blend of high protein dairy powder(s) and concentrated protein liquids (which may optionally be cultured after concentration) that is added to a conventionally fermented cream cheese curd to achieve the high protein cream cheese compositions exhibiting the texture, smoothness, and organoleptic properties of conventional cream cheeses. In some approaches, the blend of protein powder(s) and concentrated protein liquids achieves desired functionalities because the addition of the protein liquid enables an effective powder-to-moisture ratio for achieving proper hydration of the protein powders. In other approaches, the use of concentrated protein liquid enables a higher pH in the composition upon addition of the dry protein sources (which is predominately casein) such that the casein remains in solution rather than precipitating out. To this end, the compositions herein may be produced via a unique, sequential blending method where the concentrated dairy liquid is added to the cheese curd before the addition of powders.

Normally, cream cheese is stored under refrigeration conditions and has a smooth and butter-like consistency. It can be sold as a brick or in softer forms within a tub. The texture and body of cream cheese at refrigeration temperatures is such that the cream cheese can be sliced and/or spread. Previously, high protein levels in cream cheese tended to be detrimental to the texture, consistency, mouthfeel, and/or spreadability. However, even with the higher levels of protein of the compositions herein, the cream cheese compositions of the present disclosure exhibit the smoothness, spreadability, and/or mouthfeel of conventional cream cheese at both room (about 70° F. to about 75° F.) and refrigeration (about 35° F. to about 45° F.) temperatures. Cream cheese-like spreads or cream cheese-like products are products or compositions that may not meet all standards of identity for cream cheese but have many of the functional properties of cream cheese. As used herein, the term “cream cheese” or “cream cheese composition” refers to traditional-type cream cheese products (e.g., cream cheese processes involving separation of curds and whey), cream cheese products made without separation of curds and whey (so-called wheyless process cream cheese), imitation cream cheese products (e.g., cream cheese products including non-dairy fats, such as vegetable oil), and the like.

Turning to more of the specifics, the high protein cream cheese products or compositions herein may generally include cheese curd, cultured dairy liquid, protein powders, and moisture in select relationships to achieve the high protein and/or calcium levels and maintain the desired product characteristics. In some approaches, the cream cheese composition may include about 89% to about 94% liquid ingredients, about 6 to about 11% protein powder ingredients, and optional ingredients, but the composition may vary based on the selected application. Each of the features of the compositions will be discussed in more detail below.

In one approach, the high protein cream cheese compositions herein having the organoleptic characteristics of cream cheese with lower amounts of protein may generally include about 8 to about 20 percent total protein provided from a select blend of cheese curd, cultured dairy liquid, and one or more high protein powders. As described further herein, the high protein powders generally have about 70 percent or greater protein relative to the protein powder in some aspects. The compositions herein may also include an amount of total fat, but not more than about 14 percent total fat. In some aspects, the high protein cream cheese composition include a select powder-to-moisture ratio from about 0.08 to about 0.25 and a protein-to-fat ratio from about 0.7 to about 3.5 so that the high protein cream cheese composition exhibits the spreadability of cream cheese with lower amounts of protein. In other aspects, the composition herein may include about 280 to about 385 mg/100 grams of calcium provided from the cheese curd, cultured dairy liquid, one or more high protein powders, and mixtures thereof.

With respect to the high total protein levels, the compositions herein may include about 10 to about 20 percent total dairy protein provided from the curd, cultured dairy liquid, and one or more high protein powders. In other approaches, the compositions may include about 10 to about 18, about 10 to about 15, about 12 to about 15, about 14 to about 18, or about 16 to about 20 percent total protein. The high amounts of protein, which as discussed further below, includes high levels of casein, remains hydrated and/or in solution, and forms a smooth, creamy texture. In various embodiments, the cheese curd and cultured dairy liquid may provide at least about 50 percent of the total protein to the composition. In other embodiments, the cheese curd and protein powder(s) may provide at least about 50 percent of the total protein to the composition. In yet other embodiments, the cultured dairy liquid and protein powder may provide at least about 50 percent of the total protein to the composition. In some approaches, the cheese curd may provide at least about 50 percent of the total protein to the composition or the cultured dairy liquid may provide at least about 50 percent of the total protein to the composition. In various embodiments, the protein powder may provide at least about 50 percent of the total protein to the composition.

In some approaches, the compositions herein include fat. For instance, the composition may include up to about 14 percent total fat, such as up to about 12, up to about 10, or up to about 8 percent total fat. In other approaches, the compositions may also include about 6 to about 14, about 6 to about 12, about 8 to about 12, about 8 to about 10, or about 10 to about 12 percent total fat. In various embodiments, the cheese curd may provide at least about 50 percent of the total fat to the composition. In other embodiments, the cultured dairy liquid may provide at least 50 percent of the total fat to the composition. In yet other approaches, the total fat is provided by a composition of the fat provided in the cheese curd and the fat provided in the cultured dairy liquid.

The high protein cream cheese may also include high levels of moisture. In various embodiments, the compositions may include up to about 75 percent moisture, such as up to about 72 percent moisture. In some approaches, the cheese may include, about 59 to about 75, about 59 to about 72, about 60 to about 75, about 62 to about 68, about 63 to about 67, about 64 to about 68, about 64 to about 71, about 65 to about 70, about 61 to about 70, or about 68 to about 71 percent moisture. Moisture may include or consist of water and water soluble components in the cheese curd, cultured dairy liquid, and/or pre-hydrated protein powder(s). In various embodiments, the cheese curd may provide at least about 50 percent of the total moisture to the composition. In other embodiments, the cultured dairy liquid may provide at least about 50 percent of the total moisture to the composition. In yet other embodiments, the protein powder may be pre-hydrated as a slurry or cake and, in some approaches, provide a portion of and at least about 50 percent of the total moisture to the composition. In such approaches, the pre-hydrated protein powder may include a protein cake having about 15 to about 45 percent moisture, a protein paste having about 46 to about 76 percent moisture, or a protein slurry having about 77 to about 82 percent moisture. In other approaches, the cream cheese composition may include more moisture than required under the current Standards of Identity for typical cream cheese and may be considered a cream cheese spread, product, or composition.

The high protein cream cheese compositions herein may also include high levels of calcium fortification achieved, in some approaches, without added calcium powders, salts, or other types of non-dairy calcium fortification. In various approaches, the compositions may include about 280 to about 385 mg of calcium per about 100 grams of the composition, such as about 280 to about 345, about 300 to about 365, about 325 to about 365, about 300 to about 338, and about 330 to about 380 mg of total calcium per about 100 grams of the composition. In various embodiments, the high levels of calcium may be provided by combinations of the cheese curd, the cultured dairy liquid, and/or the added high protein powders. For example and in some approaches, the cheese curd and protein powder may provide at least about 50 percent of the total calcium to the composition. In other approaches, the cultured dairy liquid and protein powder may provide at least about 50 percent of the total calcium to the composition. In yet other embodiments, the cheese curd and cultured dairy liquid may provide at least about 50 percent of the total calcium to the composition. In yet further embodiments, the cheese curd may provide at least about 50 percent of the total calcium to the composition or the cultured dairy liquid may provide at least about 50 percent of the total calcium to the composition. In some alternative embodiments, the protein powder may provide at least about 50 percent of the total calcium to the composition.

To achieve the high levels of protein herein, the cream cheese compositions may start with a cheese curd or cheese curd base having an elevated level of protein. For instance and in some approaches, the cheese curd may include up to about 10 percent protein, up to about 25 percent fat, and a pH of about 4 to about 5. The cheese curd may independently include higher levels of protein than typical cream cheese curd. For instance, the curd or cheese base useful in the compositions herein may include about 6 to about 10 percent protein (in other approaches, about 6 to about 8, about 7 to about 10, about 7 to about 9, about 8 to about 10, or about 8 to about 9 percent protein). The curd may also include fat and independently include about 20 to about 25 percent fat (in other approaches, about 20 to about 24, about 20 to about 22, about 21 to about 25, about 22 to about 24, or about 23 to 25 percent fat). The curd also has a pH consistent with conventional cream cheese curd and has a pH independently selected from about 4 to about 5 (in other approaches, about 4.2 to about 4.8, about 4.2 to about 4.7, about 4.3 to about 4.6, about 4.4 to about 4.8, about 4.4 to about 4.6, or about 4.5 to about 4.9). The cheese curd may include high levels of casein relative to whey. For example, the curd may have a ratio of casein to whey of about 80:20 or higher levels of casein, such as about 85:15, about 88:12, about 90:10, about 92:8, about 95:5, or 98:2. In one approach, the cheese curd may be provided from Neufchatel and the like curds. As will be discussed further below, use of higher protein curd, such as Neufchatel is not sufficient alone to achieve the high protein levels desired in the cream cheese compositions herein.

To boost the total levels of protein in the compositions, they may also include an added dairy liquid, such as a concentrated dairy liquid that may be a skim milk retentate concentrated by ultrafiltration. The dairy liquid may also be cultured or fermented to add cheese-like notes to the product. In various embodiments, the fermented skim milk retentate may include moisture up to about 80 percent, protein up to about 20 percent, and fat up to about 1.5 percent, and a pH of about 4 to about 5. In other embodiments, the fermented skim milk retentate may independently include about 75 to about 80, about 75 to about 79, about 75 to about 77, about 76 to about 80, about 76 to about 78, or about 77 to about 80 percent moisture. The added dairy liquid may be concentrated and include about 14 to about 20 percent protein (in other approaches, about 14 to about 18, about 14 to about 16, about 15 to about 20, about 15 to about 17, about 16 to about 20, about 16 to about 18, and about 18 to about 20 percent protein). The added dairy liquid may be a lower fat dairy liquid and include about 0.1 to about 1.5 fat (in other approaches, about 0.5 to about 1, about 0.7 to about 1.3, and about 1 to about 1.5 percent fat). This dairy liquid may also have a pH independently selected from about 4.7 to about 5.2, about 4.7 to about 4.9, about 4.8 to about 5.2, and about 4.9 to about 5.1. Without wishing to be bound to any particular theory, it is believed that the cultured skim milk retentate may contribute to the higher amounts of protein and moisture in the composition. The added dairy liquid may also include high levels of casein. For instance and in various embodiments, the added dairy liquid, such as a cultured skim retentate, may include a ratio of casein to whey of about 80:20 or high levels of casein. In alternative approaches, the added dairy liquid may be a cultured cream. Even combined with the cheese curd, the added dairy liquid in many instances is not sufficient to boost the protein levels to those desired.

To increase the protein levels further, the compositions herein may also include one or more dairy protein powders, such as one or more high protein dairy powders. For instance, the protein powders may include about 70 to less than 100 percent protein relative to the protein powder, such as about 70 to about 99, about 70 to about 80, about 72 to about 98, about 75 to about 95, about 80 to about 90, about 85 to about 95, about 88 to about 98, or about 90 to about 98 percent protein relative to the protein powder. In some approaches, the protein powder may be selected from the group consisting of milk protein concentrate, milk protein isolate, whey protein concentrates, whey protein isolates, and mixtures thereof. In some instances, the whey protein sources may be less desired. Alternatively whey sources may be native whey proteins. The protein powders may come from a cheese making process or, alternatively, from microfiltration of milk or other liquid dairy source. The one or more high protein powders may also have a high ratio of casein to whey of about 80:20 or higher levels of casein, such as about 85:15, about 88:12, about 90:10, about 92:8, about 95:5, or about 98:2 as needed for a particular application.

In alternative approaches, the compositions may also include cultured cream, high protein powders and concentrated milk fat. This may be used with conventional curd instead of the higher protein curds mentioned above. Additionally, the methods and compositions herein discuss culturing of the ingredients. The methods and compositions may also include direct acidification instead of culturing and, in some approaches, may not acidify or culture until all ingredients are mixed together and thereby including a single culturing step rather than multiple, separate culturing steps.

Balancing the levels of protein, moisture, and fat from each protein source is one feature that enables the high protein compositions herein to achieve the desired characteristics similar to compositions without the levels of protein, moisture, and/or fat called for herein. For instance, the compositions may include select ratios of powder-to-moisture and/or select ratios of protein-to-fat. For instance, exemplary powder-to-moisture ratio may be independently selected from about 0.08 to about 0.25, such as about 0.1 to about 0.2, about 0.12 to about 0.18, about 0.12 to about 0.15, about 0.13 to about 0.20, about 0.14 to about 0.22, about 0.16 to about 0.20, about 0.17 to about 0.25, about 0.08 to about 0.15, or about 0.18 to about 0.24. While not wishing to be limited by theory, it is believed that in some approaches, the selected ratio of power-to-moisture helps aid in properly hydrating the proteins (which in many instances are predominately casein) and achieving the smooth texture and creaminess with the high levels of protein in the composition.

Prior cream cheese typically had either higher fat levels and lower protein or much lower to no fat levels and higher protein. The compositions herein are able to achieve high protein with moderate levels of fat yet still achieve the creaminess of spreadable cream cheese. For instance, the protein-to-fat ratio may be independently from about 0.7 to about 3.5, such as about 0.7 to about 3.3, 1.1 to about 3.0, about 1.1 to about 2.5, about 1.2 to about 1.8, about 1.3 to about 1.7, about 1.4 to about 1.9, about 1.4 to about 1.8, about 1.5 to about 1.9, or about 1.6 to about 1.8. In other embodiments, the cream cheese composition may include a ratio of moisture-to-protein powders from 85% to 13.5%.

The composition may also have a ratio of casein to whey of about 80:20 or higher levels of casein, such as about 85:15, about 88:12, about 90:10, about 92:8, about 95:5, or in some approaches, about 98:2. In at some alternative embodiments, the ratio of casein to whey may be less than about 80:20, such as about 78:22, about 75:25, and about 70:30.

As suggested by the above, the high protein cream cheese compositions herein have higher levels of dairy proteins from multiple sources and multiple types of sources (balanced amounts of curd, dairy liquid and dairy powder in the powder-to-moisture and protein-to-fat relationships). That is, the high levels of protein are provided by a cheese curd with high levels of protein, a concentrated liquid dairy protein source (which may be acidified or cultured), and one or more added high protein powders.

To prepare the higher protein cream cheese, the compositions of the present disclosure may utilize a sequential protein blending process. For instance and in one approach, the method first starts with a cheese curd having an elevated protein or elevated casein level. By one approach, the cream cheese compositions or spreads may be made from a starting cheese base or curd that has about 1 gram to about 2 grams of protein per 3 gram serving size or about 6 to about 10 percent protein. Suitable starter cheeses for the curd may also have a higher casein to whey ratio such that higher levels of casein are retained in the curd after whey separation. In some approaches, the casein to whey ratio of the starting cheese is about 85:15 or higher levels of casein. As mentioned above, suitable cheese curd for the starting cheese base of the cream cheese may include Neufchatel curd, full fat curd, reduced fat curd, and blends thereof. As also mentioned above, use of these higher casein cheese curds, however, is not sufficient to obtain the levels of protein desired in the cream cheese compositions of the present disclosure.

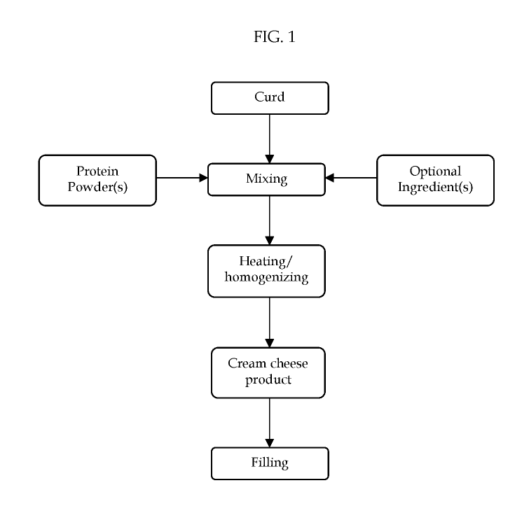

Increasing the level of protein in the cream cheese compositions further was attempted by adding high protein powders alone to the cream cheese curd. Referring to FIG. 1, exemplary high protein cream cheese compositions (Cream Cheese Compositions 1-3) were attempted by adding a high protein powder, such as, for example, milk protein concentrate (MPC 70), whey protein concentrate (WPC 80), or NUTRILAC, to a cream cheese curd obtained from cream cheese fermentation process of Neufchatel cheese to produce a cream cheese including two times the amount of protein as conventional cream cheeses or about 4 to about 5 g of protein/28 g serving. NUTRILAC is calcium reduced and generally includes about 75% protein, with the majority of the protein comprising casein. The exemplary high protein cream cheese composition may include optional ingredients, such as lactic acid, sorbic acid, sugar, and emulsifiers and/or stabilizers, such as salt, carob, and carrageenan, flavorings, colorants, vitamins, such as vitamin A, and water as shown in the tables below. The Cream Cheese Compositions 1-3 included components or ingredients as set forth in Table 1 below:

TABLE 1
Exemplary Cream Cheese Compositions 1-4.

| | Cream Cheese Compositions | | | |
|---|---|---|---|---|
| Component | 1 | 2 | 3 | 4 |
| Curd | 50.54% | 50.54% | 56.72% | 50% |
| WPC 80 | 15.32% | 0 | 0 | 0 |
| MPC 70 | 0 | 15.32% | 0 | 8.14% |
| Cultured Retentate | 0 | 0 | 0 | 25% |
| NUTRILAC | 0 | 0 | 13.36% | 0 |
| Sorbic Acid | 0.05% | 0.05% | 0 | 0.05% |
| Whey | 33% | 0 | 0.05% | 0 |
| Water | 0 | 33% | 28.58% | 15.51% |
| Salt | 0.75% | 0.75% | 0.75% | 0.75% |
| Lactic Acid | 0.1% | 0.1% | 0.3% | 0.3% |
| Carob Gum | 0.25% | 0.25% | 0.25% | 0.25% |
| Result | Grainy | Grainy | Grainy | Smooth |

The mixing may be performed in any suitable blending equipment for mixing dairy products, such as mixers available from Breddo (Kansas City, Miss.), which may include a heating component (for example, a steam jacketed kettle). The method may comprise heating the mixture, for example, within the kettle, to a temperature from about 150° F. to about 175° F. The method may then include homogenizing the heated mixture in a homogenizer at pressures from about 500 psi to about 6000 psi to form the cream cheese product. Homogenization may be carried out at increased pressures but any method that is effective to homogenize dairy substrates may be used. The final cream cheese product may be packaged by any process known in the art.

The final product of Cream Cheese Compositions 1-3 (Table 1), however, lacked the texture, smoothness, and organoleptic properties of conventional cream cheeses. The texture was gritty, grainy, sandy, and mouth-drying. It was believed that the final product was not fully hydrated. Without wishing to be bound to any particular theory, it is believed that the higher levels of protein provided by the high protein powders exceeded the solubility of the curd, was not properly hydrated because there was too much dry powder competing for water, and/or the casein protein in the dry powder was not soluble or precipitated out of solution at the lower pH of the fat curd.

The curd formed in a conventional cream cheese process typically has a pH of about 4.3 to about 4.6 (prior to addbacks, such as gums, flavors, minerals, salts, etc.). Cream cheese curd formed from Neufchatel cheese has a similar pH. High protein powders typically have high levels of casein, and casein tends to precipitate out of solution at pH 4.6 or below. Thus, not only does adding high levels of protein powders to conventional cream cheese curd have hydration problems such that the powders compete for moisture and do not hydrate properly, but the high levels of casein in protein powders can, at least in part, precipitate out of solution when added at the pH levels of conventional cream cheese curd. Both shortcomings tend to result in sandy, grainy textures in the resultant product.

Under the current Standards of Identity, cream cheese is required to contain no more than 55 percent moisture. Thus, the addition of more water to the curd to increase the solubility and hydration of the protein powders may result in more moisture than permitted under current standards. Further, increased moisture levels in the cream cheese will often result in a cream cheese product that is too soft and does not have the desired firmness of normal, higher fat cream cheese. Therefore, gums traditionally have been added to low fat cream cheese in order to impart a firmer texture. Unfortunately, the addition of extra gums and the like also results in a more gel-like texture that is less desirable than the smooth, creamy texture of normal cream cheese, and does not spread as well as normal cream cheese.

Exemplary cream cheese-making processes suitable to prepare cream cheese curd are conventional except for the use of higher protein starting cheese base described above and are described, for example, in U.S. Pat. No. 7,687,095, U.S. Pat. No. 7,655,267, U.S. Pat. No. 7,611,743, U.S. Pat. No. 6,406,736, and U.S. Publication No. 2009/0297660, which are each incorporated herein by reference in their entirety. In traditional processes for making cream cheese, uncultured whole milk and/or skim milk and sweet cream are blended in pre-selected proportions to form a cream cheese mix. The cream cheese mix is pasteurized and homogenized, after which it is cooled, usually to a temperature between about 16.7 to about 43° C., and is then inoculated with a lactic acid culture. Conventionally, a cream and milk mixture is cultured with lactic acid-forming bacteria to convert lactose in the mixture to lactic acid. The culturing continues until the pH drops sufficiently to form a curd. Rennet may also be added. Neufchatel curd may be prepared with less rennet and a long curdling time. In various embodiments, full fat curd may be prepared. The cheese curds generally have different fat to protein ratios of milk and cream that may relate to the fat of the starting cheese base. The curd may be separated from the whey and processed to form cream cheese curd.

Additionally, hybrid processes that incorporate optional dairy ingredients into conventional cream cheese processes may also be used. The term “optional dairy ingredient” is defined in 21 C.F.R. §133.124(d) as “Cream, milk, skim milk, buttermilk, cheese whey, any of the foregoing from which part of the water has been removed, anhydrous milk fat, dehydrated cream, skim milk cheese for manufacturing, and albumin from cheese whey.” In these processes, additional ingredients, including salt and stabilizers, are typically added.

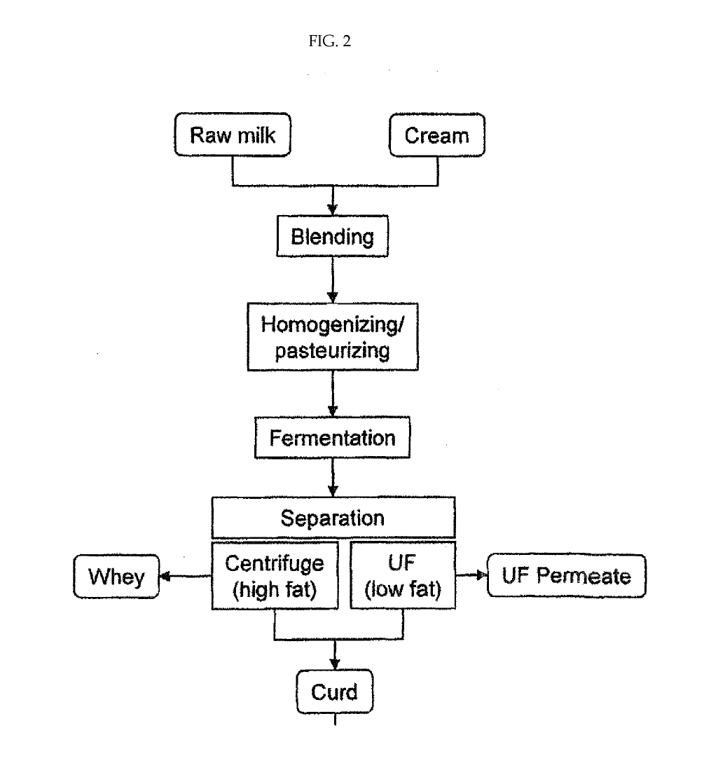

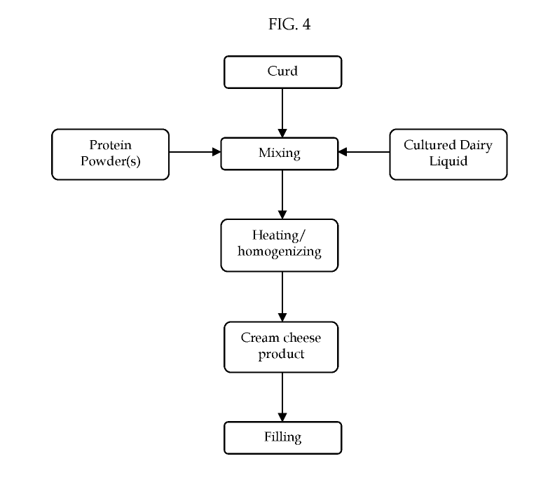

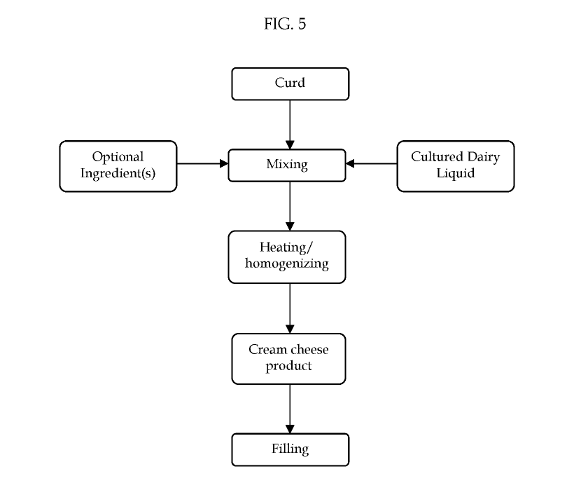

As simply boosting the protein levels with curd and protein powders alone produced less desired end results in terms of texture and protein hydration, select blends of curd, dairy liquid, and powders were then used to achieve the desired protein levels and end product consistency. By one exemplary approach and generally shown in FIGS. 2 to 5, methods for preparing the high protein cream cheese products or compositions of the present disclosure includes first forming a cheese base or curd as shown in FIG. 2: (a) heating a dairy base; (b) homogenizing the dairy base to form a homogenized mixture; (c) heating the homogenized mixture to a setting temperature of about 62 to about 92° F.; (d) adding a cream cheese culture to the homogenized mixture; (e) incubating the mixture of step (d) for a period of about 8 to about 20 hours; (f) if necessary, adjusting the pH of the to achieve a pH of 4.6 or less, such as by adding an edible acid (e.g., citric acid, acetic acid, lactic acid, malic acid, fumaric acid, tartaric acid, hydrochloric acid, sulfuric acid, phosphoric acid, and combinations thereof) to form curds and whey; and then (g) optionally separating the curds from the whey. Next, the protein boosting components and optional other ingredients are added as generally shown in FIGS. 4 and 5 by, for example; (e1) adding the one or more additional protein components (dairy liquid and one or more high protein powders) and (e2) optionally adding stabilizer and other ingredients to the separated curds to form a cream cheese mixture; and (f) homogenizing the cream cheese mixture to form the final cream cheese product. The final cream cheese product can then be packaged using conventional techniques, including, for example, cold or hot packing techniques. The final cream cheese product may be in the form of a cream cheese “brick” or in a softer form more typically sold in plastic containers.

In some aspects, the dairy base includes a combination of raw milk and cream. Other dairy liquids may also be included in the dairy base, if desired. The dairy base may include cultured cream, concentrated milk fat (CMF), and wheyless cream cheese. A method of making the cheese curd is illustrated in FIG. 2. Protein sources may also be included in the dairy base, including for example milk protein concentrate, whey protein concentrate, and the like.

Stabilizers suitable for inclusion in the cream cheese product include, for example, gums, salts, emulsifiers, and mixtures thereof. Suitable gums include, for example, xanthan gum, locust bean gum, guar gum, carrageenan, carob, and the like, as well as mixtures thereof. Suitable salts include, for example, sodium chloride, other edible salts, and the like, as well as mixtures thereof. Suitable emulsifiers include, for example, sodium citrate, potassium citrate, monosodium phosphate, disodium phosphate, trisodium phosphate, sodium aluminum phosphate, sodium tripolyphosphate, sodium hexametaphosphate, dipotassium phosphate, sodium acid pryrophosphate, and the like, as well as mixtures thereof. The moisture content of the cream cheese is controlled by the amount of water added to the formulation; if necessary, it can be further adjusted by evaporation or the addition of more water. In various embodiments, the cream cheese product may be free from emulsifiers or emulsifying salts, such as sodium tripolyphosphate and other emulsifying salts. As used herein “free from or free of” generally means less than about 0.5 percent, less than about 0.1 percent, less than about 0.05 percent, or none at all.

As discussed above, the additional dairy protein component may include a concentrated protein slurry or dairy liquid (optionally cultured after concentration), high protein powder(s), and combinations thereof. In one approach, the additional dairy protein is a blend of concentrated protein slurry or liquid obtained from a cultured skim milk retentate and one or more high protein powders. In various embodiments, a protein ratio in the compositions herein to achieve high level of protein may be a ratio of protein liquid to protein powder, based on weight percent, of about 55/45 to about 75/25, and in some approaches about 69/31 to about 72/28. In various embodiments, the ratio of the cultured skim retentate to protein powders may be from about 39 to about 49% Neufchatel curd, about 18 to about 26% cultured skim retentate, and about 6 to about 11% protein powders.

In other embodiments, the added dairy protein component may include a select amount of a dairy powder obtained from a milk protein concentrate, milk protein isolate, whey protein concentrate, whey protein isolate, or mixtures thereof. Examples of milk protein concentrates and milk protein isolates include, but are not limited to, NUTRILAC RM-4620, NUTRILAC RM-7020, NUTRILAC CH-7813, NUTRILAC QU-7560, NUTRILAC YO-7700, NUTRILAC LD-350, NUTRILAC 561, PSMD T42, PSMD T43, and SA-55-5 (Aria, Denmark), MPC42, MPC70, MPC75, MPC80, and MPC85 (Dairy Management Inc.), MPC80 (WMB Nutritional Corp., Rancho Cucamonga, Calif.), MPC5170, MPC5180, MPC80 Proteint milk protein isolate 5003 (Proteint Inc., St. Paul, Minn.), and ULTRANOR milk proteins (Kerry Dairy Ingredients, Ireland). Examples of whey protein concentrates and whey protein isolates include, but are not limited to, whey Protein Concentrate 7034H heat stable (Proteint Inc., St. Paul, Minn.), NUTRILAC 7020 (Aria, Denmark), THERMAX 34 and THERMAX 70 whey protein concentrates, THERMAX 690 whey protein isolate, PROLACTA 80 and PROLACTA 90 native whey protein (Lactalis, Les Placis, France), and Solmiko MPC 80 and Solmiko MPI (Glanbia Nutritionals, Inc. Monroe Wis.). Milk protein concentrates are preferred in some approaches and, in other approaches, the powders have a ratio of casein to whey of at least about 80:20 or higher levels of casein, such as, for example, greater than 80 to about 20. Cream cheese products comprising substantial amounts of non-casein protein, such as whey protein and whey protein concentrate, may not achieve the same texture as cream cheeses made with casein. The powders may have a high level of protein, such as about 70 percent or higher and low levels of moisture, such as less than about 10 percent moisture (in some cases, less than about 5 percent moisture or about 2 to about 7 percent moisture or about 3 to about 5 percent.)

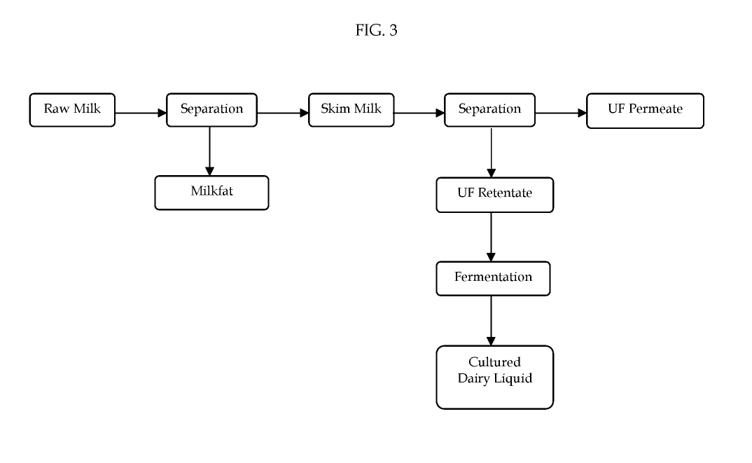

In various embodiments, the added dairy protein component may also include a concentrated liquid dairy component, such as a cultured skim retentate. For example, the protein liquid may include skim retentate obtained from ultrafiltration of skim milk that is thereafter cultured. A method of making cultured skim retentate is illustrated in FIG. 3. If needed, the milk fat may be separated from raw milk to produce skim milk. The skim milk may be separated (fractioned) by membrane separation to provide the skim retentate. Membrane separation may comprise microfiltration, ultrafiltration, nanofiltration, and reverse osmosis. Membrane separation may separate (fractionate) milk components according to particle size or molecular weight. The permeate may comprise components that pass through the membrane, such as, for example lactose, minerals, water. In various embodiments, skim milk may be separated by ultrafiltration to produce a UF retentate that contains the majority of the casein and whey from the skim milk. The skim UF retentate may comprise components that do not pass through the membrane, such as, for example, about 80% casein and about 20% whey protein. In various embodiments, about 100% skim milk or skim milk blended with ultrafiltered cream cheese whey (about 10-13% solids) up to a ratio of about 90:10 ratio may be concentrated by ultrafiltration. The UF process may concentrate the skim milk or skim milk UF acid whey blend to about 5× to about 5.5× (based on protein levels) so that the retentate has about 14 to about 16% protein. In the retentate, the casein proteins are still in a form that are functional and soluble as opposed to the caseins in powders that are less functional and soluble due to the spray drying or other powder formation process.

Commercially available membranes are described , e.g., in H.G. Kessler: Membrane Separation-Processes in “Food and Bio Process Engineering”, Verlag A. Kessler, 5^{th} ed., pages 56-99 (2002); V. V. Mistry, J. L. Maubois: Application of membrane separation technology to cheese production in “Cheese, Chemistry, Physics and Microbiology”, Vol. 1, 3^{rd} ed., edited by Fox et al., Elsevier Academic Press, pages 261-285 (2004); M. Cheryan: Handbuch Ultrafiltration, B. Behr's Verlag (1990); R. Rautenbach, R. Albrecht: Membrane Processes, John Wiley & Sons (1989). In various embodiments, the skim retentate may comprise about 80% casein and about 20% whey protein.

In some approaches, the UF skim retentate may be fermented to produce a cultured skim retentate. In an exemplary fermentation step for this added dairy liquid, a bacteria culture may be added to inoculate the uncultured skim retentate. The fermentation can be carried out in conventional manner, for example at room temperature for at least about 10 hours and up to a maximum of between 1 to 2 days, and in some approaches, for a period of from about 15 to about 20 hours. In one aspect, suitable cultures may comprise a lactic starter culture, such as any lactic acid-producing bacteria used in conventional cream cheese making. Suitable lactic acid-producing bacteria include Lactococcus or Leuconostoc such as Lactococcus lactis, Lactococcus cremoris, Lactotococcus lactis, spp. diacetyllactis, Leuconostoc cremoris, and the like. Furthermore, it is also possible to use exopolysaccharide-producing cultures. However, it is preferred to use a lactic starter culture selected from the group consisting of mesophilic and thermophilic lactic acid-producing bacteria, more preferably mesophilic bacteria. A single type of lactic acid-producing bacteria or a combination of two or more thereof can be used. During fermentation, the pH of the skim retentate may decrease, and it may be desirable to adjust the pH of the cultured skim retentate after the fermentation, preferably to the range of from about 4.4 to about 5.2. This may be achieved by the addition of a pH modifying agent, including acids and preferably unfermented milk blend. In various embodiments, the cultured skim retentate may comprise about 75 to about 79% moisture, about 0.5 to about 1.5% fat, and about 14 to about 16% protein. The cultured skim milk retentate may have a pH ranging from about 4.75 to about 5.2.

Referring to FIG. 4, a method of making a high protein cream cheese composition having organoleptic characteristics of cream cheese with lower amounts of protein may generally comprise providing a cheese curd having about 6 to about 10 percent protein, about 20 to about 25 percent fat, and a pH of about 4.3 to about 4.6, adding a cultured dairy liquid having a higher pH to the cheese curd to raise the pH and form a dairy mixture, blending one or more high protein dairy powders having about 70 percent protein or more, relative to the dairy powder, into the dairy mixture to form a cream cheese mixture, and homogenizing the cream cheese mixture to form the high protein cream cheese composition having about 8 to about 20 percent protein and the spreadability of cream cheese with lower amounts of protein. In various embodiments, method of making a high protein cream cheese composition may comprise providing optional ingredients (not shown) as described herein to the cheese curd, cultured dairy liquid, and/or one or more high protein dairy powders prior to, during, or after the blending step.

Referring again to FIGS. 4 and 5, according to various embodiments, a method of making a high protein cream cheese product may generally comprise mixing a cultured skim retentate fraction, a protein powder, and a dairy base or curd to form a cream cheese mixture, and homogenizing and/or pasteurizing the cream cheese mixture to form the final high protein cream cheese product. In some approaches, the cultured skim retenate is added to the dairy base or curd prior to addition of the protein powders and optional ingredients. This sequential addition of the added protein may be advantageous, in some approaches, because the higher pH of the cultured skim retentate will raise the pH of the overall blend of curd and retentate above pH 4.6. In this manner, when the additional protein powders, which are high in casein as discussed above, will tend not to precipitate the case out of solution. Homogenization may be carried out prior to or after the pasteurization. In various embodiments, optional components, such as stabilizers, flavors, colorants, pH modifying agents, salts, fruits, nuts and the like may be added to the cream cheese mixture. The final cream cheese product may be filled into tubs or plastic containers or any other suitable packaging means. Typically, the homogenized cream cheese is hot-filled into a container, sealed, and cooled.

Referring to FIG. 5, exemplary high protein cream cheese composition (Cream Cheese Composition 4) included components or ingredients as set forth in Table 1, above. Without wishing to be bound to any particular theory, it is believed that the cultured retentate provided moisture and protein to Cream Cheese Composition 4 that were not found in Cream Cheese Compositions 1-3. Without wishing to be bound to any particular theory, the cultured skim retentate fraction may increase the moisture content of the cream cheese mixture and/or increase the pH of the cream cheese mixture. The additional moisture and protein in Cream Cheese Composition 4 reduces the amount of water and protein powders needed to achieve about the same protein levels. Without wishing to be bound to any particular theory, it is believed that the specific amounts of dairy base, cultured skim retentate, and protein powder work together in a synergistic manner such that when all three components are present in specific, controlled amounts, that higher levels of protein in the final cream cheese product may be achieved. These results are obtained with values that are more than additive of the results expected of each element individually. This synergistic effect is also achieved while maintaining other desired properties such as texture, smoothness, and organoleptic properties.

In various embodiments, a cream cheese composition may include components or ingredients as set forth in Table 1, sample 4 above, and Table 2 below. In various embodiments, the cream cheese composition may comprise a pH from about 4.5 to about 5.2, such as about 4.7 to about 5 and about 4.8 to about 5.0. The compositions may also be flavored and further include about 5 to about 7 percent sugar or other sweetener.

TABLE 2
High Protein Cream Cheese, exemplary ranges

| Component | First Range | Second Range |
|---|---|---|
| Fat | 6-14% | 8-12% |
| Moisture | 59-72% | 61-70% |
| Protein | 10-20% | 12-15% |
| Protein powders | 6-15% | 8-9% |
| Cultured skim retentate | 18-26% | 20-24% |
| Salt | 0.7-1.5% | 0.8-1% |
| Calcium | 280-385 mg/100 g | 332-338 mg/100 g |
| Sugar | 0-10% | optionally, 5-7% |
| pH | 4.5-5.2 | 4.7-5 |

In various embodiments, the cream cheese composition may comprise from 6-14% fat, 59-72% moisture, 10-20% protein, 6-15% protein powder(s), 18-26% cultured skim retentate, 0.7-1.5% salt, and 280-385 mg Ca/100 g and a pH from 4.5-5.2, and optionally up to 10% flavorants, such as sugar, when a flavored high protein cream cheese composition is desired.

In various embodiments, the cream cheese composition may comprise from 8-12% fat, 61-70% moisture, 12-15% protein, 8-9% protein powder(s), 20-24% cultured skim retentate, 0.8-1.0% salt, and 332-3338 mg Ca/100 g and a pH from 4.7-5, and 5-7% flavorants, such as sugar, when a flavored high protein cream cheese composition is desired.

In various embodiments, the cream cheese composition may comprise from 8-12% fat, 67-71% moisture, 13-16% protein, 8-15% protein powder(s), 19-25% cultured skim retentate, 0.8-1.0% salt, and 280-320 mg Ca/100 g and a pH from 4.8-5. In various embodiments, the cream cheese composition may comprise from 9-11% fat, 67-69% moisture, 13-15% protein, 8-9% protein powder(s), 22-24% cultured skim retentate, 0.8-1.0% salt, and 280-320 mg Ca/100 g and a pH from 4.8-5. In various embodiments, the cream cheese composition may comprise from 9-11% fat, 62-64% moisture, 13-15% protein, 0.8-1.0% salt, and 280-320 mg Ca/100 g and a pH from 4.8-5.0.

In various embodiments, the cream cheese composition may comprise from 8-12% fat, 59-71% moisture, 13-16% protein, 8-15% protein powder(s), 19-25% cultured skim retentate, 0.7-1.0% salt, and 280-385 mg Ca/100 g, and optionally 5-7% sugar or flavor(s), and a pH from 4.8-5.0. In various embodiments, the cream cheese composition may comprise from 9-11% fat, 62-64% moisture, 13-15% protein, 13-15% protein powder(s), 20-22% cultured skim retentate, 0.7-1.0% salt, and 290-330 mg Ca/100 g, and optionally 5-7% sugar or flavor(s), and a pH from 4.8-5.0.

In various embodiments, the cream cheese composition may comprise from 8-12% fat, 67-71% moisture, 13-16% protein, 8-15% protein powder(s), 19-25% cultured skim retentate, 0.8-1.0% salt, and 280-320 mg Ca/100 g, and optionally 5-7% sugar or flavor(s), and a pH from 4.8-5.0. In various embodiments, the cream cheese composition may comprise from 9-11% fat, 67-69% moisture, 13-15% protein, 8-9% protein powder(s), 22-24% cultured skim retentate, 0.8-1.0% salt, and 280-320 mg Ca/100 g, and optionally 5-7% sugar or flavor(s), and a pH from 4.8-5.

The process for producing a high protein cream cheese product in accordance with the present disclosure may be extended to a process for preparing a food product comprising cream cheese and one or more additional food product components. This process comprises the steps of producing cream in accordance with the process as defined above and combining the cream cheese thus produced with the one or more additional food product components. The one or more additional food product components include, by way of example, a confectionery product and a bakery product. The step of combining the cream cheese and the one or more additional food product components may be exemplified by any one of a filling step, a coating step and a layering step. For example, the cream cheese may be filled into another food product component by injection, e.g., injected into a confectionery product or a bakery product; or the cream cheese may be coated on another food product component and, after coating, may optionally be covered by yet another food product component; or the cream cheese may be coextruded with one or more additional food product components, thus forming a layered food product.

Advantages and embodiments of the high protein cream cheese described herein are further illustrated by the following examples; however, the particular conditions, processing schemes, materials, and amounts thereof recited in these examples, as well as other conditions and details, should not be construed to unduly limit this method. All percentages are by weight unless otherwise indicated.

### EXAMPLES

### Example 1

Referring to FIG. 5, a high protein cream cheese composition according to various embodiments was prepared by mixing about 25% cultured skim retentate, about 8.14% protein powder (MPC-70), about 50% Neufchatel curd, about 0.05% sorbic acid, about 15.51% water, about 0.75% salt, about 0.30% lactic acid, and about 0.25% carob gum for about 5 minutes while heating up to 175° F. The cultured skim retenate was first added to the curd, then the other ingredients were blended in. The mixture was processed to produce the cream cheese. The cream cheese included 10.60 percent fat, 58.80 percent total solids, 0.88 percent salt, and 14 percent protein. The textures of the cream cheese products were similar based on sensory assessment.

### Examples 2-14

High protein cream cheeses according to various embodiments were prepared following the process of Example 1. The high protein cream cheese compositions included 427 mg/100 g calcium from the skim retentate and 82.2 mg/100 g from the Neufchatel curd. The results are shown in Tables 3 and 4.

TABLE 3
High Protein Cream Cheese Compositions

| Compo- | | | |
|---|---|---|---|
| nent | First Range | Second Range | Third Range |
| Fat | 8.75-11.68% | about 10% | 10.6% |
| Moisture | 67.08-70.79% | about 68% | 68.86% |
| Protein | 13.03-15.32% | about 14% | 14% |
| Salt | 0.81-0.94% | about 0.9% | 0.88% |
| Calcium | 281-383 mg/100 g | about 300 mg/100 g | 317.88 mg/100 g |
| pH | 4.83-6.65 | about 4.9 | 5.33 |

TABLE 4
High Protein Cream Cheese Compositions (Examples 2-14)

| | Cream Cheese Compositions | | | | | | | | | | | | | |
|---|---|---|---|---|---|---|---|---|---|---|---|---|---|---|
| Component | 2 | 3 | 4 | 5 | 6 | 7 | 8 | 9 | 10 | 11 | 12 | 13 | 14 | Average |
| Fat (%) | 9.17 | 10.29 | 10.91 | 11.55 | 11.68 | 11.46 | 10.31 | 11.03 | 10.96 | 10.6 | 8.75 | 10.06 | 11.01 | 10.60 |
| Moisture (%) | 68.65 | 68.03 | 68.7 | 68.56 | 67.08 | 67.72 | 70.35 | 68.94 | 69.19 | 69.14 | 69.08 | 70.79 | 68.92 | 68.86 |
| pH | 6.65 | 5.59 | 5.59 | 5.57 | 5.22 | 5.14 | 5.13 | 5.13 | 5.13 | 5.14 | 5.32 | 4.83 | 4.88 | 5.33 |
| Protein (%) | 13.46 | 14.15 | 14.1 | 14.71 | 14.87 | 14.33 | 13.32 | 13.59 | 13.58 | 13.56 | 15.32 | 13.03 | 14.01 | 14.00 |
| Salt (%) | 0.89 | 0.88 | 0.88 | 0.87 | 0.88 | 0.9 | 0.85 | 0.92 | 0.83 | 0.89 | 0.81 | 0.95 | 0.94 | 0.88 |
| Calcium | | | | | | 383 | 299 | 281 | 305 | 306 | 353 | 301 | 315 | 317.88 |
| (mg/100 g) | | | | | | | | | | | | | | |

### Example 15-18

Flavored high protein cream cheese according to various embodiments were prepared following a modified process of Example 1 including lower amounts of cultured skim retentate and Neufchatel curd, higher amounts of water and protein powder, and an addition of sugar. The flavored high protein cream cheese compositions included 427 mg/100 g calcium from the skim retentate and 82.2 mg/100 g from the Neufchatel curd. The results are shown in Table 5 and 6.

TABLE 5
High Protein Cream Cheese Compositions

| Compo- | | | |
|---|---|---|---|
| nent | First Range | Second Range | Third Range |
| Fat | 9.23-9.91% | about 10% | 9.53% |
| Moisture | 64.97-66.74% | about 63% | 66.44% |
| Protein | 12.98-13.8% | about 14% | 13.35% |
| Salt | 0.71-0.84% | about 0.9% | 0.76% |
| Calcium | 294-330 mg/100 g | about 300 mg/100 g | 302.25 mg/100 g |
| pH | 4.87-4.88 | about 4.9 | 4.87 |

TABLE 6
Flavored High Protein Cream Cheese Compositions (Examples 15-18)

| | Flavored Cream Cheese Compositions | | | | |
|---|---|---|---|---|---|
| Component | 15 | 16 | 17 | 18 | Average |
| Fat (%) | 9.91 | 9.68 | 9.23 | 9.31 | 9.53 |
| Moisture (%) | 66.74 | 64.97 | 67.51 | 66.54 | 66.44 |
| pH | 4.88 | 4.67 | 4.88 | 4.88 | 4.88 |
| Protein (%) | 13.8 | 13.31 | 12.98 | 13.33 | 13.35 |
| Salt (%) | 0.84 | 0.76 | 0.71 | 0.73 | 0.76 |
| Calcium | 330 | 294 | 295 | 290 | 302.25 |
| (mg/100 g) | | | | | |

As generally used herein, the articles “one”, “a”, “an”, and “the” refer to “at least one” or “one or more”, unless otherwise indicated. As generally used herein, the terms “including” and “having” mean “comprising”. As generally used herein, the term “about” refers to an acceptable degree of error for the quantity measured, given the nature or precision of the measurement. Typical exemplary degrees of error may be within 20%, within 10%, or within 5% of a given value or range of values.

All numerical quantities stated herein are to be understood as being modified in all instances by the term “about” unless otherwise indicated. The numerical quantities disclosed herein are approximate and each numerical value is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding techniques. Notwithstanding the approximations of numerical quantities stated herein, the numerical quantities described in specific examples of actual measured values are reported as precisely as possible.

All numerical ranges stated herein include all sub-ranges subsumed therein. For example, ranges of “1 to 10” and “between 1 and 10” are intended to include all sub-ranges between and including the recited minimum value of 1 and the recited maximum value of 10. Any maximum numerical limitation recited herein is intended to include all lower numerical limitations. Any minimum numerical limitation recited herein is intended to include all higher numerical limitations.

All percentages and ratios are calculated by weight unless otherwise indicated. All percentages and ratios are calculated based on the total weight of the compound or composition unless otherwise indicated.

In the above description, certain details are set forth to provide a thorough understanding of various non-limiting embodiments of the compositions and methods described herein. One of ordinary skill in the art will understand that the non-limiting embodiments described herein may be practiced without these details. In other instances, well-known structures and methods associated with the compositions and methods may not be shown or described in detail to avoid unnecessarily obscuring descriptions of the non-limiting embodiments described herein.

This disclosure describes various features, aspects, and advantages of various non-limiting embodiments of compositions and methods. It is understood, however, that this disclosure embraces numerous alternative embodiments that may be accomplished by combining any of the various features, aspects, and advantages of the various non-limiting embodiments described herein in any combination or sub-combination that one of ordinary skill in the art may find useful.

While particular non-limiting embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A high protein cream cheese composition having organoleptic characteristics of cream cheese with lower amounts of protein, the high protein cream cheese composition comprising:
about 8 to about 20 percent total protein provided from a cheese curd, a cultured dairy liquid, and one or more high protein powders having about 70 percent or greater protein relative to the protein powder;
an amount of total fat, but not more than about 12 percent total fat; and
a powder-to-moisture ratio from about 0.08 to about 0.25 and a protein-to-fat ratio from about 0.7 to about 3.5 so that the high protein cream cheese composition exhibits the spreadability of cream cheese with lower amounts of protein.

2. The high protein cream cheese composition of claim 1, further comprising about 6 to about 14 percent total fat and about 59 to about 72 percent moisture.

3. The high protein cream cheese composition of claim 1, wherein the cheese curd includes about 6 to about 10 percent protein, about 20 to about 25 percent fat, and a pH of about 4.3 to about 4.6.

4. The high protein cream cheese composition of claim 1, wherein the cheese curd has a ratio of casein to whey of about 85:15 or greater levels of casein.

5. The high protein cream cheese composition of claim 1, wherein the cheese curd is Neufchatel curd.

6. The high protein cream cheese composition of claim 1, wherein the cultured dairy liquid includes a fermented skim milk retentate produced by ultrafiltration.

7. The high protein cream cheese composition of claim 1, wherein the fermented skim milk retentate has about 75 to about 80 percent moisture, about 14 to about 20 percent protein, and fat, but no more than about 1.5 percent fat.

8. The high protein cream cheese composition of claim 1, wherein the fermented skim milk retentate has a pH of about 4.7 to about 5.2.

9. The high protein cream cheese composition of claim 1, wherein the one or more high protein powders are selected from the group consisting of milk protein concentrate, milk protein isolate, whey protein concentrates, whey protein isolates, and mixtures thereof.

10. The high protein cream cheese composition of claim 1, wherein the one or more high protein powders have a ratio of casein to whey of about 80:20 or higher amounts of casein.

11. The high protein cream cheese composition of claim 1, further including about 280 to about 385 mg/100 grams of calcium provided from one of the cheese curd, the cultured dairy liquid, the one or more high protein powders, and mixtures thereof.

12. The high protein cream cheese composition of claim 1, wherein the high protein cream cheese composition is free of added emulsifying salts.

13. The high protein cream cheese composition of claim 1, wherein the high protein cream cheese composition has a ratio of casein to whey of about 80:20 or higher casein.

14. A method of making a high protein cream cheese composition having organoleptic characteristics of cream cheese with lower amounts of protein, the method comprising:
providing a cheese curd having about 6 to about 10 percent protein, about 20 to about 25 percent fat, and a pH of about 4.3 to about 4.6;
adding a cultured dairy liquid having a higher pH to the cheese curd to raise the pH and form a dairy mixture;
blending one or more high protein dairy powders having about 70 percent protein or more, relative to the dairy powder, into the dairy mixture to form a cream cheese mixture; and
homogenizing the cream cheese mixture to form the high protein cream cheese composition having about 8 to about 20 percent protein and the spreadability of cream cheese with lower amounts of protein.

15. The method of claim 14, wherein the cream cheese composition has about 8 to about 14 percent total fat and about 59 to about 72 percent moisture.

16. The method of claim 14, wherein the cheese curd has a ratio of casein to whey of about 85:15 or greater levels of casein.

17. The method of claim 14, wherein the cheese curd is Neufchatel curd.

18. The method of claim 14, wherein the cultured dairy liquid is a fermented skim milk retentate produced by ultrafiltration.

19. The method of claim 14, wherein the fermented skim milk retentate has about 75 to about 80 percent moisture, about 14 to about 20 percent protein, and fat, but no more than about 1.5 percent fat.

20. The method of claim 19, wherein the fermented skim milk retentate has a pH of about 4.7 to about 5.2.

21. The method of claim 14, wherein the one or more high protein powders are selected from the group consisting of milk protein concentrate, milk protein isolate, whey protein concentrates, whey protein isolates, and mixtures thereof.

22. The method of claim 14, wherein the one or more high protein powders have a ratio of casein to whey of about 80:20 or higher amounts of casein.

23. The method of claim 14, further including about 280 to about 385 mg/100 grams of calcium provided from one of the cheese curd, the cultured dairy liquid, the one or more high protein powders, and mixtures thereof.

24. The method of claim 14, wherein the high protein cream cheese composition is free of added emulsifying salts.

25. The method of claim 14, wherein the high protein cream cheese composition has a ratio of casein to whey of about 80:20 or higher casein.
